(19) United States
(12) Patent Application Publication
(10) Pub. No.: US 2010/0110067 A1
(43) Pub. Date: May 6, 2010

(54) ACTIVE MATRIX TYPE LIQUID CRYSTAL DISPLAY

(75) Inventor: KEITARO YAMASHITA, Kobe (JP)

Correspondence Address: Flash Intellectual Property, Inc.;Attn. Cheng-Ju Chiang, P.O. Box 766, Chino, CA, 91708, US

(73) Assignee: TPO DISPLAYS CORP., Chu-Nan (TW)

(21) Appl. No.: 12/607,070

(22) Filed: Oct. 28, 2009

(30) Foreign Application Priority Data
Oct. 28, 2008 (JP) 2008-277228

(51) Int. Cl. G09G 3/36; G06F 3/038

(52) U.S. Cl. 345/215; 345/98

(57) ABSTRACT

An active matrix type liquid crystal display is disclosed. The liquid crystal display comprises a plurality of pixel elements arranged in the form of a matrix. Each of the pixel elements comprises a liquid crystal element, a dynamic memory cell and a switch device. The dynamic memory cell is disposed at the intersection point of a source line and a gate line to periodically perform refreshing for inversing the output status of the dynamic memory cell, wherein the transmittance of the liquid crystal element is controlled by a digital output of the dynamic memory cell. The switch device is disposed between the dynamic memory cell and the liquid crystal element and uses a control signal to control the connection between the output of the dynamic memory cell and the liquid crystal elements.

### FIELD OF THE INVENTION

The present invention relates to an active matrix type display, and more particularly, to a display including at least one memory provided in pixels.

### BACKGROUND OF THE INVENTION

An active matrix type display includes display elements and memories, and the display elements are disposed in pixels which are formed by gate lines and source lines crossed in the form of a matrix, and the memories maintain the data provided to the display elements.

Although the memories can be static or dynamic memories, considering the area occupied by the memories, the dynamic memories are mostly used.

Furthermore, although the conventional memory in the pixel is only 1 bit, in order to display better gray scale with multi-scale, multi-bit memories have been developed, for example, 4 bits. Although 4 memories are needed to be 4-bit in the following description, the following description will be started from a simple structure with 1-bit memory, firstly.

Referring to FIG. 1, presented herein is a circuit diagram showing a pixel of a liquid crystal display (LCD) having the conventional dynamic memory according to a simple example, and the more detailed structure thereof is disclosed in WO Patent Publication No. 04090854 (JP Patent Publication No. 2006-523323).

Referring to FIG. 1 again, a control transistor TR controlled by a gate line GL supplies the data from a source line SL to one end of a liquid crystal cell LQ, and the other end thereof is connected to a common electrode Common. A DRAM cell 1 is connected to a connecting point between the control transistor TR and the liquid crystal cell LQ. The DRAM cell 1 is configured to store the data supplied to the liquid crystal cell LQ. Therefore, when the image does not vary, the transmittance of the liquid crystal cell using the stored data can be kept in the same status.

It is generally understood that the DRAM has to be refreshed periodically for maintaining the memory data. For the advantages of low area occupancy in a pixel opening and low power consumption, it is preferred to use the active matrix type display, such as active matrix LCD.

However, when using the liquid crystal, according to the electrochemical characteristics thereof, in a status of continuously applying the same voltage thereto, the movement of the liquid crystal deteriorates, and the so-called image sticking effect occurs. As a result, the polarity of the voltage applied to the liquid crystal has to be periodically inversed.

Referring to FIG. 2, presented herein is a schematic circuit diagram showing a conventional structure using the refreshed DRAM output to inverse the polarity of the liquid crystal.

Referring to FIG. 2 again, in this structure, similar to FIG. 1, the control transistor TR is used to provide the data from the source line SL to the DRAM cell 1. The signal outputted from the output point 2 of the DRAM cell 1 is provided to the gates of an n-channel TFT and a p-channel TFT, and the drains of the two TFTs are commonly connected to the liquid crystal cell. A reference voltage VrefA and a reference voltage VrefB, of which the polarity is opposite to the reference voltage VrefA, are applied to the sources of the two TFTs, respectively. The two TFTs form a digital-to-analog (D/A) converter 3.

In this structure, the input of the refreshing signal of the DRAM cell 1 is used to change the output voltage of the DRAM. The n-channel TFT and the p-channel TFT output a voltage to a pixel electrode 4 in accordance with a relationship between the reference voltage VrefA and the reference voltage VrefB, and the liquid crystal cell can present the transmittance according to the voltage. The polarity of the voltage applied to the liquid crystal can be inversed by the DRAM output voltage in each time of the refreshing.

Namely, when the DRAM output voltage is a high level, and the nTFT is turned on, the voltage of the pixel electrode is VrefA. When the refreshing of the DRAM is proceeded, the DRAM output is changed to a low level. In the meanwhile, nTFT is turned off, and the pTFT is turned on, and therefore the voltage of the pixel electrode is Vref B.

However, the refreshing frequency of the DRAM corresponds to the maintenance of the memory content, and the refreshing required for the pixel, i.e. the polarity inversion, is used to prevent the image sticking effect. Therefore, the refreshing required for the pixel has not to be executed so frequently as the refreshing of the DRAM. The refreshing frequencies therefore the pixel and the DRAM need not to be identical.

As a result, a pixel circuit, which executes the refreshing of the DRAM and the polarity inversion of the pixel at the same time, has unnecessary power consumption, and thus it is desirable to provide an active matrix type display which has low power consumption when using the DRAM.

### SUMMARY OF THE INVENTION

Therefore, an aspect of the present invention is to provide an active matrix type display for reducing power consumption when including memory cell in circuit for refreshing.

According to one embodiment of the present invention, the active matrix type liquid crystal display comprises a plurality of pixel elements arranged in the form of a matrix, wherein the pixel elements comprise a plurality of liquid crystal elements, at least one dynamic memory cell and a switch device. The dynamic memory cell is disposed at the intersection points of a plurality of source lines and a plurality of gate lines to periodically perform refreshing for inversing the output status of the dynamic memory cell, wherein the transmittance of each of the liquid crystal elements is controlled by a digital output of the dynamic memory cell. The switch device is disposed between the dynamic memory cell and the liquid crystal elements and using a control signal to control the connection between the output of the dynamic memory cell and the liquid crystal elements.

The refreshing is executed once or twice in a short interval periodically, and the control signal provided by the switch device is at a disenable status before the refreshing and is at a enable status just after the refreshing, a refreshing frequency of the twice refreshing in the short interval is higher than an inversing frequency of the once refreshing which inverses the voltage polarity applied to the liquid crystal cells.

Furthermore, the active matrix type liquid crystal display further comprises a D/A converter disposed between the dynamic memory cell and the switch device and converts the digital output of the dynamic memory cell to an analog voltage in accordance with the control signal.

Therefore, the active matrix type liquid crystal display of the present invention includes the switch device disposed between the output of the embedded memory and the liquid crystal cell, and uses the refreshing of the DRAM to inverse the voltage polarity applied to the liquid crystal cell with a low frequency, thereby reducing power consumption.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic circuit diagram showing a pixel of a liquid crystal display having the conventional dynamic memory;

FIG. 2 is a schematic circuit diagram showing a conventional structure using the refreshed DRAM output to inverse the polarity of the liquid crystal;

FIG. 3 is a block diagram showing a pixel structure of an active matrix type liquid crystal display according to one embodiment of the present invention;

FIG. 4 is a block diagram showing a pixel structure of an active matrix type liquid crystal display according to another embodiment of the present invention;

FIG. 5 is a waveform view showing the action of the conventional example of FIG. 2 corresponding to a relationship between the refreshing of the DRAM and an enabling switch;

FIG. 6 is a waveform view illustrating the action in FIG. 4 for inversing the voltage polarity applied to the liquid crystal cell;

FIG. 7 is a block diagram showing a schematic structure of an active matrix type liquid crystal display with multi-scale using DRAM according to one embodiment; and

FIG. 8 is a circuit diagram showing a DAC structure which uses the 2-bit data to take four gradation voltages V1-V4 out.

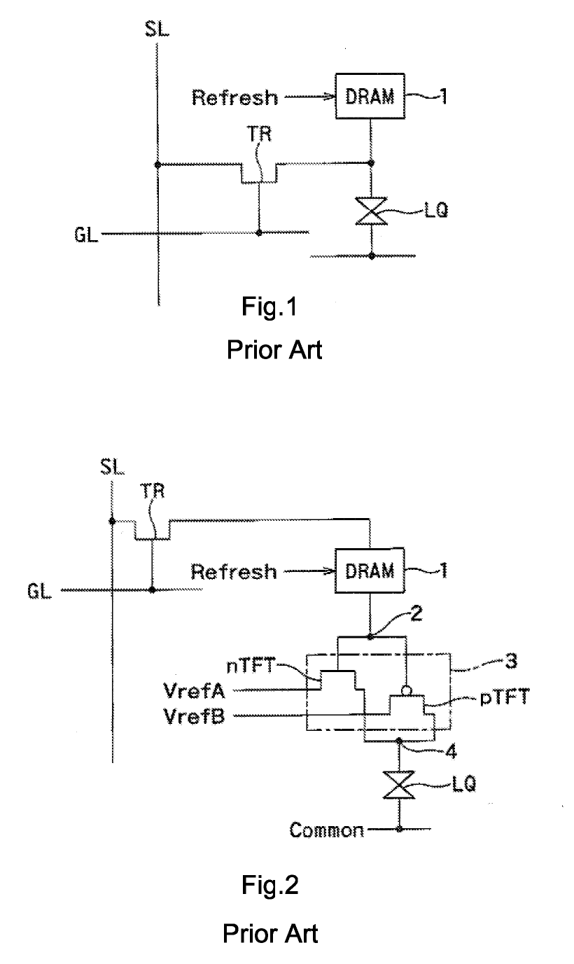

### DETAILED DESCRIPTION OF THE PREFERRED EMBODIMENT

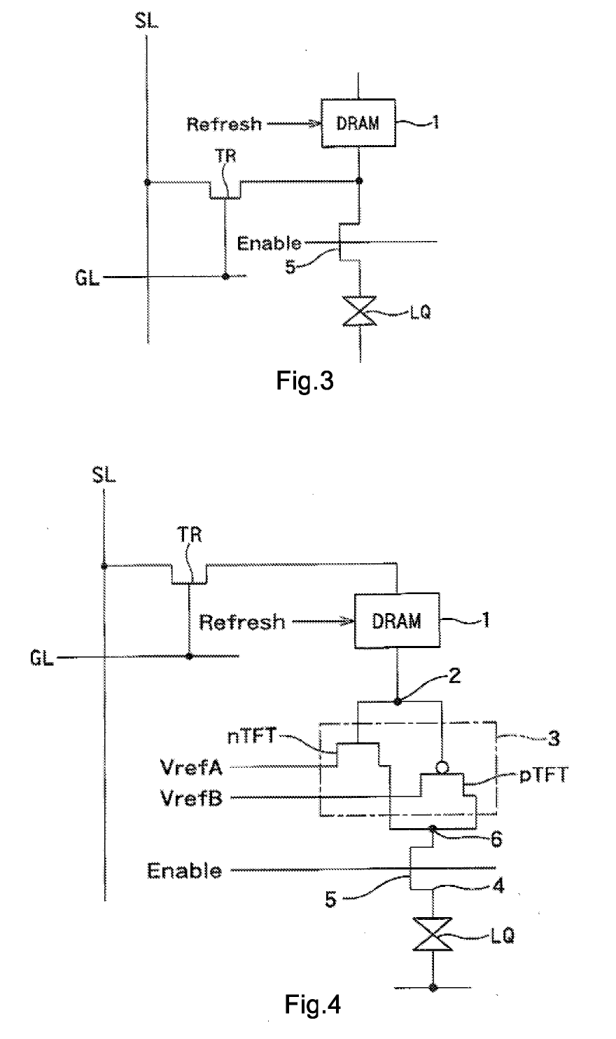

In order to make the illustration of the present invention more explicit and complete, the following description is stated with reference to FIG. 3 through FIG. 8.

Referring to FIG. 3, presented herein is a block diagram showing a pixel structure of an active matrix type liquid crystal display according to one embodiment of the present invention. The active matrix type liquid crystal display comprises a plurality of pixel elements arranged in the form of a matrix, wherein the pixel elements comprise a plurality of liquid crystal elements LQ, at least one dynamic memory cell (DRAM 1) and a switch device 5. The DRAM 1 is disposed at the intersection points of a plurality of source lines SL and a plurality of gate lines GL to periodically perform refreshing for inversing the output status of the DRAM 1, wherein the transmittance of each of the liquid crystal elements LQ is controlled by a digital output of the DRAM 1. The switch device 5 is disposed between the DRAM 1 and the liquid crystal elements LQ and uses a control signal Enable to control the connection between the output of the DRAM 1 and the liquid crystal elements LQ.

In the present embodiment, the switch device 5 is controlled by a control signal Enable to perform switching is disposed between the DRAM 1 and the liquid crystal cell LQ.

When the control signal ENABLE at a high level is in an enable status, the TFT switch 5 is conducted. When the control signal ENABLE at a low level is in a disenable status, the TFT switch 5 is not conducted.

Accordingly, in the disenable status, the DRAM output can be prevented from being applied to the liquid crystal cell.

Furthermore, the voltage polarity applied to the liquid crystal cell can be changed by using the polarity inversion of the output of the DRAM1 synchronized with the refreshing timing.

Referring to FIG. 4, presented herein is a block diagram showing a pixel structure of an active matrix type liquid crystal display according to another embodiment of the present invention corresponding to FIG. 2 and using the same reference numbers.

Similar to FIG. 2, the signal outputted from the output point 2 of the DRAM cell 1 is simultaneously provided to the gates of an n-channel TFT and a p-channel TFT, and the drains of the two TFTs are commonly connected to the liquid crystal cell. A reference voltage VrefA and a reference voltage VrefB, of which the polarity is opposite to the reference voltage VrefA, are applied to the sources of the two TFTs, respectively, and a common connecting point of the drains of the two TFTs is a D/A converter (DAC) output point 6. The TFT switch 5 is connected between the DAC output point 6 and the liquid crystal cell LQ, and the control signal ENABLE is connected to the gate of the TFT switch 5. The n-channel TFT and p-channel TFT form the D/A converter.

When the control signal ENABLE at the high level is in the enable status, the TFT switch 5 is conducted. When the control signal ENABLE at the low level is in the disenable status, the TFT switch 5 is not conducted. Therefore, when the control signal ENABLE is at the low level, the refreshing signal inputted into the DRAM cell 1 can change the output voltage of the DRAM. Even the n-channel TFT (nTFT) and p-channel TFT (pTFT) apply the voltage to the DAC output point 6 in accordance with the relationship between the reference voltage VrefA and the reference voltage VrefB, the voltage can not be applied to the liquid crystal cell LQ.

In the other hand, when the control signal ENABLE at the high level is in the enable status, the TFT switch 5 is conducted, and the potential of the drain common connecting point 6 is conducted to a pixel electrode 4 and applied to the liquid crystal cell LQ. The liquid crystal cell LQ can present the transmittance according to the voltage.

In the above-mentioned structure, first, the relationship between the refreshing and the enabling of the DRAM is illustrated by a comparison example.

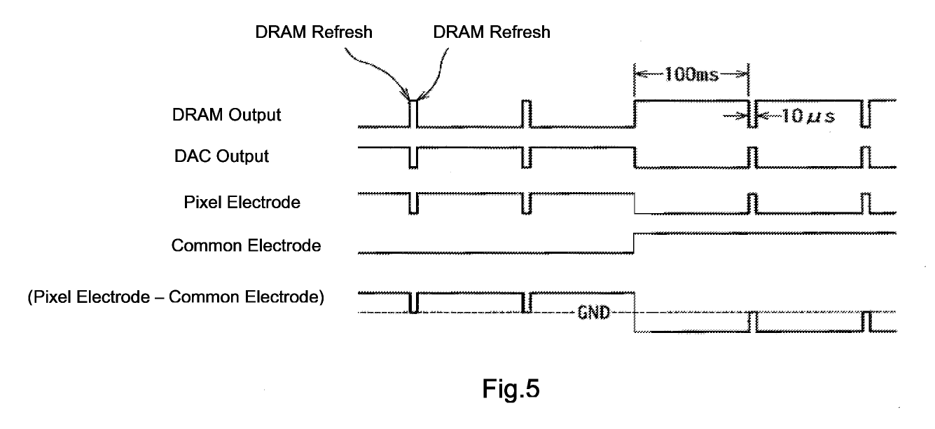

Referring to FIG. 5, presented herein is a timing chart of the comparison example showing the action of the conventional example of FIG. 2. In this example, by using the refreshing of the DRAM, the variation of the DRAM output corresponds to the variation of the D/A converter. Consequently, the level variation of the pixel electrode is larger, and the level variation and the level difference between the level of the pixel electrode and the level of the common electrode occur.

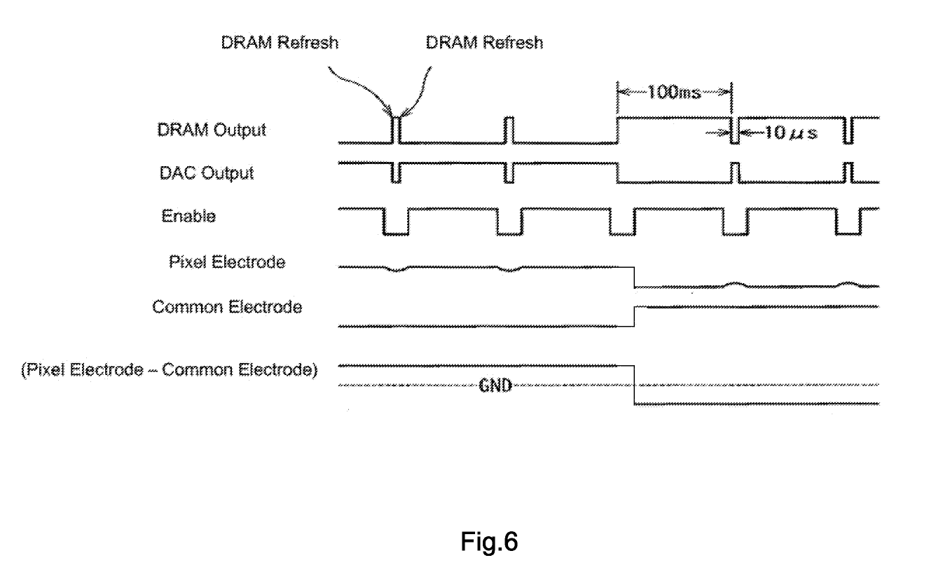

Referring to FIG. 6, presented herein is a timing chart illustrating the action of inversing the voltage polarity applied to the liquid crystal cell in FIG. 4 for solving the conventional problem.

As shown in the highest section, the DRAM refreshing is executed twice in a very short interval, such as 10 μs, and then returns to the original level and proceeds repeatedly in a designated period, such as 100 μs, and the refreshing for inversing the polarity of the liquid crystal is executed once.

The DAC output of the second section is substantially an inversion signal of the DRAM output signal.

The signal ENABLE of the third section corresponds to the DRAM refreshing. The first refreshing is at the low level, i.e. the disenable status, and then the second refreshing is at the high level, i.e. returning to the original enable status.

Referring to the level of the pixel electrode of the fourth section, when the signal ENABLE is at the low level, the DAC output varies. However, the voltage level transmitted to the pixel electrode does not vary. Since the above-mentioned twice refreshing is executed in a very short interval, such as 10 μs. Therefore, in comparison with the whole, the slight variation can be regarded as that no variation occurs. When executing the once refreshing to inversing the polarity of the liquid crystal, the variation of the DAC output is continuous to proceed, and thus the level of the pixel electrode varies significantly.

The level of the common electrode of the fifth section is inversed in synchronization of the once refreshing. Consequently, the level of (pixel electrode-common electrode) of the sixth section can have the voltage level variation of the polarity inversion relative to a ground voltage level (GND).

Furthermore, the refreshing of the DRAM is generally executed by using the pulse with substantially 50% duty cycle. In the present invention, the normal refreshing is executed twice in a very short interval, and the refresh of the polarity inversion is merely executed once.

As a result, before and after the pulse for refreshing is changed to the high level, the enable switch is in the disenable status. After the twice DRAM refreshing is executed in the short interval, and the refreshing pulse returns to the low level, the enable switch is in the enable status. When proceeding the polarity inversion of the liquid crystal, the enable switch is in the disenable status before the refreshing pulse being at the low level.

Therefore, the output polarity of the DRAM output returns to the same status immediately after the refreshing, and the refreshing signal is almost maintained at the same level in the same period. Accordingly, in the period which the switch is at the disenable status, the level of the pixel electrode almost does not vary. Furthermore, even the slight variation occurs, it almost can not be recognized in the gray scale, thereby improving the image quality.

In that manner, with the use of the enable switch of the present embodiment, the refreshing and the voltage level control of the liquid crystal can be separated, and the signal for refreshing when enabling is also used to inverse the polarity of the liquid crystal. Namely, when refreshing, the twice refreshing in the short interval, which does not effect the variation of the level of the pixel electrode, is executed, and the liquid crystal polarity is changed, and the once refreshing is executed, and the refreshing signal can be also used to the polarity inversion of the liquid crystal. It is very sufficient to execute the polarity inversion of the liquid crystal for 1 second. In the present embodiment, the polarity inversion is executed once in each ten times of the refreshing. Therefore, the refreshing frequency of the polarity inversion of the liquid crystal is significantly lower than the refreshing frequency of the DRAM, thereby greatly reducing the power consumption.

Furthermore, in the embodiment illustrated in FIG. 3 without the D/A converter, the relationship between the refreshing pulse and the enabling signal is also the same. However, since the level of the pixel electrode could not be varied by using the D/A converter, the polarity inversion could be executed by the level variation of the DRAM output (the first section in FIG. 6).

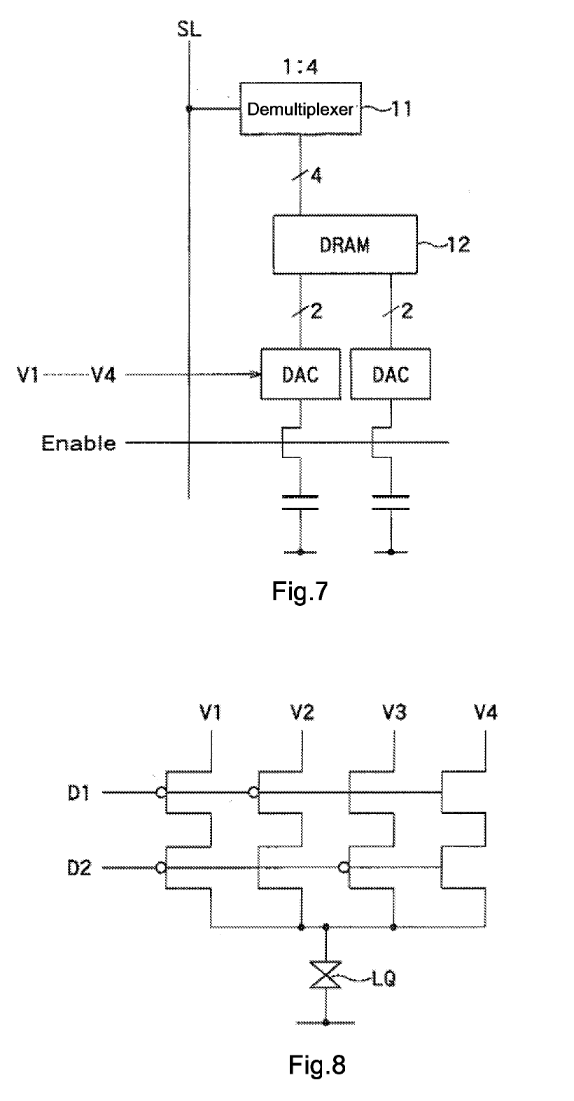

Referring to FIG. 7, presented herein is a block diagram showing a schematic structure of an active matrix type liquid crystal display with multi-scale using DRAM according to one embodiment.

The source line is connected to a demultiplexer 11. When the data outputted from the source line is a 4-bit signal, the demultiplexer 11 is a 1:4 type. The four sets of the data, which are taken out, are respectively memorized corresponding to the DRAM 12, i.e. the DRAM 12 is 4-bit.

The 4-bit is separated into a LSB 2-bit and a MSB 2-bit for processing.

Referring to FIG. 8, presented herein is a circuit diagram showing a DAC structure which uses the 2-bit data to take four gradation voltages V1-V4 out. Corresponding to each of the gradation voltages, two TFTs are connected in series. The gate of the upside TFT corresponds to a data D1, and the gate of the downside TFT corresponds to another data D2, thereby forming an assembly to select one of the gradation voltages. Therefore, the selected gradation voltage can be applied to the liquid crystal cell. Practically, the expected gradation voltage can be achieved by using the assembly of the scale and the scale area of the voltage.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. An active matrix type liquid crystal display, comprising;
a plurality of pixel elements arranged in the form of a matrix, wherein the pixel elements comprise:
a plurality of liquid crystal elements;
at least one dynamic memory cell disposed at the intersection points of a plurality of source lines and a plurality of gate lines to periodically perform refreshing for inversing an output status of the dynamic memory cell, wherein the transmittance of each of the liquid crystal elements is controlled by a digital output of the dynamic memory cell; and
a switch device disposed between the dynamic memory cell and the liquid crystal elements and using a control signal to control the connection between the output of the dynamic memory cell and the liquid crystal elements.

2. The active matrix type liquid crystal display of claim 1, wherein the refreshing is executed once or twice in a short interval periodically, and the control signal provided to the switch device is at a disenable status before the refreshing and is at a enable status just after the refreshing, a refreshing frequency of the twice refreshing in the short interval is higher than an inversing frequency of the once refreshing which inverses the voltage polarity applied to the liquid crystal cells.

3. The active matrix type liquid crystal display of claim 2, wherein the interval for performing the twice refreshing is less than 50% of the interval in which the refreshing is not executed.

4. The active matrix type liquid crystal display of claim 1, further comprising a D/A converter disposed between the dynamic memory cell and the switch device and converting the digital output of the dynamic memory cell to an analog voltage in accordance with the control signal.

5. The active matrix type liquid crystal display of claim 4, wherein each of the pixel elements comprises a plurality of dynamic memory cells and a demultiplexer, and the demultiplexer uses the source lines to provide multi-bit data corresponding to the dynamic memory cells.

6. The active matrix type liquid crystal display of claim 5, wherein the D/A converter uses the multi-bit data to transmit a plurality of gradation voltages to the liquid crystal cells.

7. An active matrix type liquid crystal display, comprising:
a plurality of source lines configured to transmit digital data;
a plurality of dynamic memory cells connected to the source lines, wherein the frequency of the digital data is used to perform refreshing, and the output status is inversed when performing refreshing;
a plurality pixel electrodes connected to a plurality of liquid crystal cells; and
an enabling switch device disposed between the dynamic memory cells and the pixel electrodes, wherein the enabling switch device is at a disenable status when performing refreshing;
wherein the refreshing of the dynamic memory cells is normally executed twice in a short interval, and is executed once for inversing the polarity of the analog voltage applied to the liquid crystal cells, and the frequency of the polarity inversion is less than a refreshing frequency of the dynamic memory cells.

8. The active matrix type liquid crystal display of claim 7, further comprising a D/A converter disposed between the dynamic memory cells and the switch device to convert the digital output of the dynamic memory cells to the analog voltage outputted to the pixel electrodes.
